(19) United States
(12) Patent Application Publication
(10) Pub. No.: US 2022/0394143 A1
(43) Pub. Date: Dec. 8, 2022

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Naoya TAKAYAMA, Kanagawa (JP)

(73) Assignee: FUJIFILM Business Innovation Corp., Tokyo (JP)

(21) Appl. No.: 17/535,668

(22) Filed: Nov. 25, 2021

(30) Foreign Application Priority Data
Jun. 7, 2021 (JP) 2021-095307

(51) Int. Cl. H04N 1/00

(52) U.S. Cl. CPC H04N 1/00503; H04N 1/00474; H04N 1/00506; H04N 1/00408; G06F 3/04817

(57) ABSTRACT

An information processing apparatus includes a processor configured to display images including one or more images of a first type and one or more images of a second type in a manner where the one or more images of the first type and the one or more images of the second type are distinguished from each other, in which the first type of image is an image for receiving execution of processing of a first apparatus alone, and the second type of image is an image for receiving execution of processing involving processing of a second apparatus other than the first apparatus in addition to processing of the first apparatus.

### CROSS-REFERENCE TO RELATED APPLICATIONS

This application is based on and claims priority under 35 USC 119 from Japanese Patent Application No. 2021-095307 filed Jun. 7, 2021.

### BACKGROUND

### (i) Technical Field

The present invention relates to an information processing apparatus, a non-transitory computer readable medium storing an information processing program, and an information processing method.

### (ii) Related Art

JP2019-121245A discloses an image forming apparatus on which an extension function program is loadable. The image forming apparatus includes a display unit that displays a plurality of display items for instructing function execution in the image forming apparatus, and a setting unit that sets whether or not to group and display the plurality of display items by predetermined function of the image forming apparatus. The image forming apparatus further includes a display control unit that displays at least one display item, which corresponds to the predetermined function of the image forming apparatus and is formed by grouping the plurality of display items, based on the setting in the setting unit.

JP2005-197978A discloses a multifunction machine that provides various services. The multifunction machine includes an operation display unit configured of a display unit that displays soft buttons and a transparent touch panel disposed on a front surface of the display unit in a superimposed manner. The multifunction machine further includes hard buttons that are switched by a pressing operation, and a control unit that allocates a selection function of the designated service among various services to the soft button and the hard button.

### SUMMARY

The information processing apparatus displays a first image for receiving execution of processing of a first apparatus alone and a second image for receiving execution of processing involving processing of a second apparatus other than the first apparatus in addition to the processing of the first apparatus. However, since such images are not displayed in a distinguishable manner, there is a problem in that a user cannot identify whether each image is the first image or the second image.

Aspects of non-limiting embodiments of the present disclosure relate to an information processing apparatus, a non-transitory computer readable medium storing an information processing program, and an information processing method that enable to distinguish whether an image displayed on the information processing apparatus is a first image or a second image.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to display images including one or more images of a first type and one or more images of a second type in a manner where the one or more images of the first type and the one or more images of the second type are distinguished from each other, in which the first type of image is an image for receiving execution of processing of a first apparatus alone, and the second type of image is an image for receiving execution of processing involving processing of a second apparatus other than the first apparatus in addition to processing of the first apparatus.

### BRIEF DESCRIPTION OF THE DRAWINGS

Exemplary embodiment(s) of the present invention will be described in detail based on the following figures, wherein:

FIG. 1 is a schematic view showing an example of the hardware configuration of an information processing system according to an exemplary embodiment;

FIG. 2 is a schematic view showing an example of the configuration of a processing database according to the exemplary embodiment;

FIG. 3 is a flowchart illustrating an example of information processing according to the exemplary embodiment;

FIG. 4 is a schematic view showing an example of a superimposed display screen according to the exemplary embodiment;

FIG. 5 is a schematic view showing an example of a background change screen according to the exemplary embodiment;

FIG. 6 is a schematic view showing an example of a screen only displaying icons for receiving execution of processing of a first apparatus alone, according to the exemplary embodiment;

FIG. 7 is a schematic view showing an example of a screen only displaying icons for receiving execution of processing involving processing of a second apparatus before processing of the first apparatus, according to the exemplary embodiment; and

FIG. 8 is a schematic view showing an example of a screen displaying icons for receiving execution of processing involving processing of the second apparatus after processing of the first apparatus, according to the exemplary embodiment.

### DETAILED DESCRIPTION

Hereinafter, an example of an exemplary embodiment of the present disclosure will be described referring to the drawings. In the respective drawings, identical or equivalent elements and portions are represented by identical reference numerals. The ratio of the dimensions in the respective drawings is exaggerated for convenience of description and is different from the actual ratio in some cases.

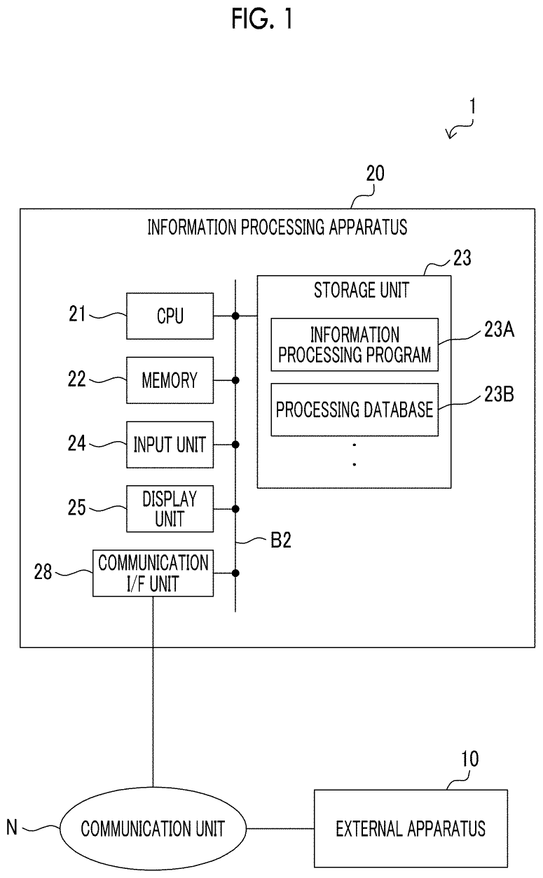

As shown in FIG. 1, an information processing system 1 according to the exemplary embodiment includes an information processing apparatus 20, and an external apparatus 10 that is an apparatus other than the information processing apparatus 20.

The external apparatus 10 and the information processing apparatus 20 can perform communication with each other via a communication unit N. In the exemplary embodiment, a communication line in an enterprise, such as a local area network (LAN) or a wide area network (WAN), is applied as the communication unit N. Alternatively, as the communication unit N, a public communication line, such as the Internet or a telephone line, may be applied or a communication line in an enterprise and a public communication line may be applied in combination. In the exemplary embodiment, a wired communication line is applied as the communication unit N. Alternatively, as the communication unit N, a wireless communication line may be applied or a wired communication line and a wireless communication line may be applied in combination.

In the exemplary embodiment, a personal computer is applied as the external apparatus 10. Alternatively, any information processing apparatus, such as a tablet terminal or a smartphone, which is an apparatus other than the information processing apparatus 20, may be applied as the external apparatus 10.

In the exemplary embodiment, an image forming apparatus is applied as the information processing apparatus 20. Alternatively, any information processing apparatus, such as a personal computer, a tablet terminal, or a smartphone, may be applied as the information processing apparatus 20.

As shown in FIG. 1, the information processing apparatus 20 according to the exemplary embodiment includes a CPU 21, a memory 22 as a temporary storage area, a nonvolatile storage unit 23, an input unit 24, a display unit 25, and a communication I/F unit 28. The respective configurations are connected via a bus B2.

The storage unit 23 is realized by a storage device, such as an HDD, an SSD, ora flash memory. An information processing program 23A is stored in the storage unit 23 as a storage medium. The CPU 21 reads such programs from the storage unit 23, develops the programs to the memory 22, and sequentially executes processes in the programs. Detailed description of execution of each program will be described below. Various databases, such as a processing database 23B, are stored in the storage unit 23.

The input unit 24 is, for example, a touch panel, and is used to receive various kinds of input information.

The display unit 25 is, for example, a liquid crystal display, and displays various kinds of information. The input unit 24 and the display unit 25 may be configured integrally as a touch panel display.

The communication I/F unit 28 is an interface for the information processing apparatus 20 to perform communication with the external apparatus 10. For the communication, for example, a wired communication standard, such as Ethernet (Registered Trademark) or FDDI, or a wireless communication standard, such as 4G, 5G, or Wi-Fi (Registered Trademark), is used.

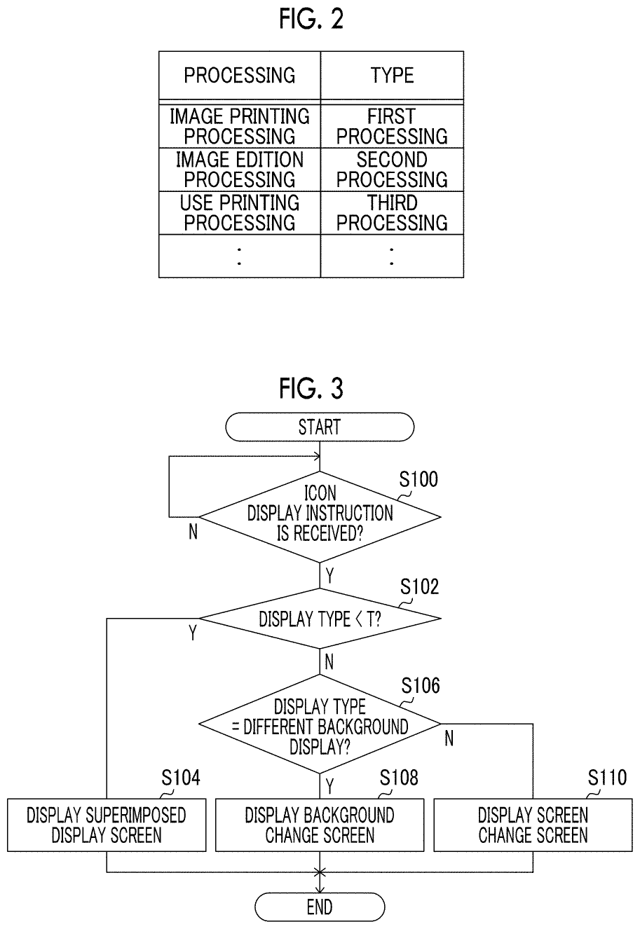

Next, the processing database 23B according to the exemplary embodiment will be described referring to FIG. 2. In the processing database 23B shown in FIG. 2, processing information that is information regarding processing to be executed by the information processing apparatus 20 is stored. In FIG. 2, each row represents the processing information. In each kind of processing information, respective kinds of information regarding processing and a type are associated.

The above-described processing is information representing processing to be executed by the information processing apparatus 20. In an example shown in FIG. 2, as the above-described processing, image printing processing by the information processing apparatus 20 and image edition processing that is processing in which the information processing apparatus 20 reads an image and the external apparatus 10 edits the image are applied. In the example shown in FIG. 2, as the above-described processing, use printing processing that is processing in which the information processing apparatus 20 performs printing using an image transmitted from the external apparatus 10 is also applied. As the above-described processing, any processing to be executed by the information processing apparatus 20, such as image reading processing by the information processing apparatus 20 and image display processing in which the external apparatus 10 displays an image read by the information processing apparatus 20, may be applied.

The above-described type is information representing a type of corresponding processing. In the example shown in FIG. 2, as the above-described type, first processing that is processing of the information processing apparatus 20 alone is applied. Furthermore, in the example shown in FIG. 2, as the above-described type, second processing that is processing of executing processing of the external apparatus 10 after processing of the information processing apparatus 20, and third processing that is processing of executing processing of the external apparatus 10 before processing of the information processing apparatus 20 are applied.

Next, the operations of the information processing apparatus 20 according to the exemplary embodiment will be described referring to FIGS. 3 to 8. In a case where a user instructs to start execution of the information processing program 23A through the input unit 24, the CPU 21 executes the information processing program 23A, whereby information processing shown in FIG. 3 is executed.

In Step S100, the CPU 21 waits until an instruction to display an icon as an image for receiving execution of processing on the display unit 25 is received through the input unit 24. In the exemplary embodiment, a case where icons corresponding to all kinds of processing stored in the processing database 23B are displayed on the display unit 25 will be described.

In Step S102, the CPU 21 reads the processing database 23B and determines whether or not the number of types of processing corresponding to the icons displayed on the display unit 25 is less than a predetermined threshold value T. In a case where determination is made that the number of types of processing corresponding to the icons is less than the predetermined threshold value T (Step S102: Y), the CPU 21 progresses to Step S104.

In Step S104, the CPU 21 displays a superimposed display screen conforming to a predetermined format on the display unit 25 and ends the information processing.

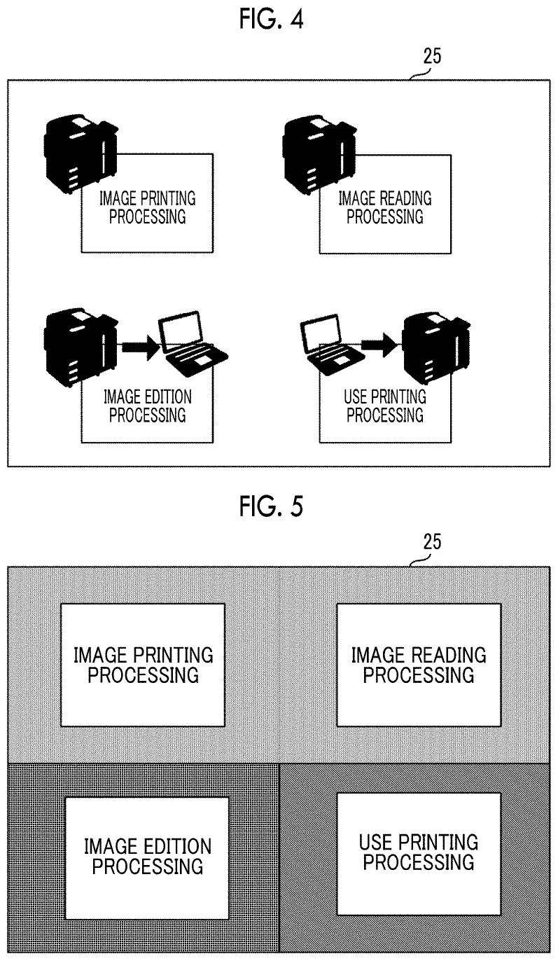

As shown in FIG. 4, on the superimposed display screen according to the exemplary embodiment, different images are displayed on a first icon for receiving execution of the first processing, a second icon for receiving execution of the second processing, and a third icon for receiving execution of the third processing in a superimposed manner. Specifically, on the superimposed display screen, an image representing an image forming apparatus as the information processing apparatus 20 is displayed on the first icon in a superimposed manner. An image forming apparatus preceding image that is an image representing an arrow from the image forming apparatus toward a personal computer as the external apparatus 10, the image forming apparatus, and the personal computer is displayed on the second icon in a superimposed manner. A personal computer preceding image that is an image representing an arrow from the personal computer toward the image forming apparatus, the image forming apparatus, and the personal computer is displayed on the third icon in a superimposed manner. The image displayed in a superimposed manner is not limited to the image representing the image forming apparatus, the image forming apparatus preceding image, and the personal computer preceding image.

On the other hand, in a case where the number of types of processing corresponding to the icons is equal to or greater than the predetermined threshold value T (Step S102: N), the CPU 21 progresses to Step S106. In Step S106, the CPU 21 reads the storage unit 23 and determines whether or not a manner of displaying the first icon, the second icon, and the third icon is set to a manner that displays the icons with different backgrounds. Ina case where the manner that displays the first icon, the second icon, and the third icon with different backgrounds is set (Step S106: Y), the CPU 21 progresses to Step S108.

In Step S108, the CPU 21 displays a background change screen conforming to a predetermined format on the display unit 25 and ends the information processing.

As shown in FIG. 5, on the background change screen according to the exemplary embodiment, backgrounds of different patterns are displayed in the first icon, the second icon, and the third icon. Alternatively, on the background change screen, backgrounds or the like of different colors may be displayed in such icons.

On the other hand, in a case where a manner that displays the first icon, the second icon, and the third icon on different screens is set (Step S106: N), the CPU 21 progresses to Step S110. In Step S110, the CPU 21 displays a screen change screen conforming to a predetermined format on the display unit 25 and ends the information processing.

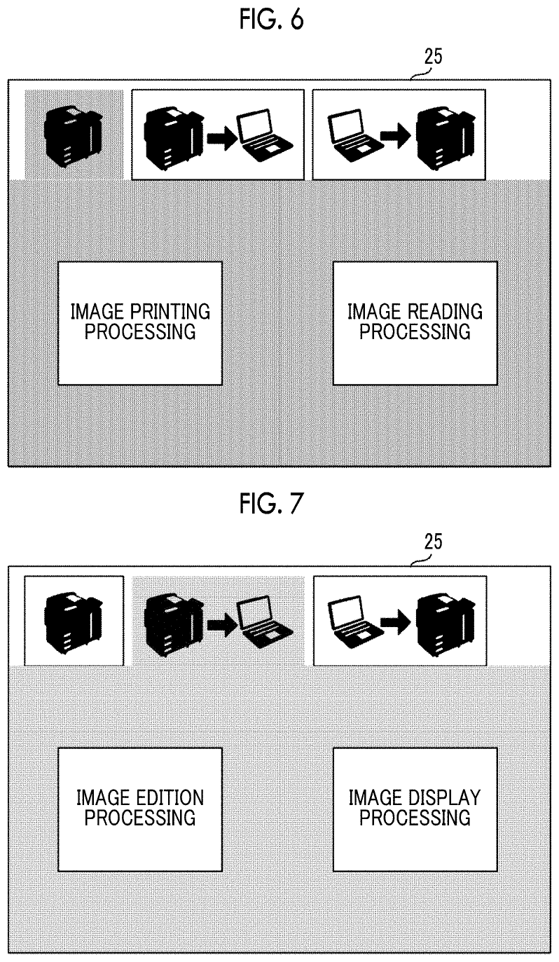

As shown in FIGS. 6 to 8, on the screen change screen according to the exemplary embodiment, the first icon, the second icon, and the third icon are displayed on different screens.

As shown in FIG. 6, on the screen change screen, in a case where the image representing the image forming apparatus as the information processing apparatus 20 is designated through the input unit 24, the first icon alone is displayed.

As shown in FIG. 7, on the screen change screen, in a case where the image forming apparatus preceding image is designated through the input unit 24, the second icon alone is displayed.

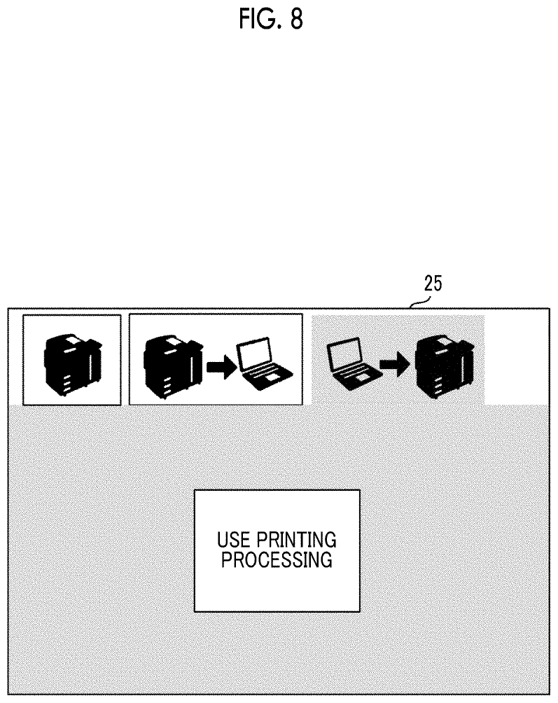

As shown in FIG. 8, on the screen change screen, in a case where the personal computer preceding image is designated through the input unit 24, the third icon alone is displayed.

In the examples shown in FIGS. 6 to 8, a case where a background of the screen change screen is different depending on the type of the processing corresponding to the icon displayed on the screen is illustrated. Alternatively, the above-described backgrounds are identical regardless of the type of the processing. On the screen change screen, a message or the like indicating the type of the processing corresponding to the icon displayed on the screen may be displayed.

Although the exemplary embodiments have been described above, the technical scope of the invention is not limited to the scope described in the above-described exemplary embodiments. Various modifications or improvements can be made to the above-described exemplary embodiments without departing from the spirit of the invention, and any embodiments obtained such modifications or improvements are also included in the technical scope of the invention.

The above-described exemplary embodiment does not limit the invention according to the claims, and not all combinations of features described in the exemplary embodiment are necessary for the invention. The above-described exemplary embodiments include various stages of invention, and various inventions are extracted by combinations of a plurality of constituents disclosed in the exemplary embodiments. Even though several constituents are removed from all constituents illustrated in the exemplary embodiments, a configuration in which several constituents are removed can be extracted as an invention as long as an effect is achieved.

For example, in the above-described exemplary embodiment, a case where the CPU 21 receives the execution of the processing of the information processing apparatus 20 that is the apparatus including the CPU 21, through the icon displayed on the display unit 25 has been described. In contrast, the CPU 21 may receive execution of processing of a first apparatus that is an apparatus other than the information processing apparatus 20 and a predetermined apparatus, through the icon displayed on the display unit 25. For example, a smartphone may be applied as the information processing apparatus 20, and an image forming apparatus may be applied as the first apparatus. In this case, a CPU provided in the smartphone displays an image for receiving execution of processing of the image forming apparatus alone and an image for receiving execution of processing involving processing of an apparatus other than the image forming apparatus in addition to processing of the image forming apparatus, in a manner to be distinguishable from each other.

In the above-described exemplary embodiment, a case where the manners of displaying the second icon for receiving the execution of the second processing and the third icon for receiving the execution of the third processing are different has been described. In contrast, the manners of displaying such icons may be identical.

In the above-described exemplary embodiment, a case where the CPU 21 switches the manners of displaying the icons depending on the number of types of the processing corresponding to the icons displayed on the display unit 25 has been described. In contrast, the CPU 21 may switch the manners of displaying the icons depending on the number of icons displayed on the display unit 25. The CPU 21 may display the icons in predetermined manners of displaying regardless of the number of types or the number of icons.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiments, although an embodiment in which the information processing program 23A is installed on the storage unit 23 has been described, the present disclosure is not limited thereto. The information processing program 23A according to the exemplary embodiment may be provided in a form of being recorded on a computer readable storage medium. For example, the information processing program 23A according to the exemplary embodiment may be provided in a form of being recorded on an optical disc, such as a compact disc (CD)-ROM or a digital versatile disc (DVD)-ROM, or a form of being recorded on a semiconductor memory, such as a universal serial bus (USB) memory or a memory card. The information processing program 23A according to the exemplary embodiment may be acquired from an external apparatus via the communication I/F unit 28.

In the above-described exemplary embodiments, although a case where the information processing is realized by a software configuration using a computer by executing the program has been described, the present disclosure is not limited thereto. For example, an embodiment may be made in which the information processing is realized by a hardware configuration or a combination of a hardware configuration and a software configuration.

In addition, the configuration of the information processing apparatus 20 described in the above-described exemplary embodiment is just an example, and it is needless to say that unnecessary portions may be removed or new portions may be added without departing from the spirit of the invention.

The flow (see FIG. 3) of the processing of the information processing program described in the above-described exemplary embodiment is also just an example, and it is needless to say that unnecessary steps may be removed, new steps may be added, or a processing order may be replaced without departing from the spirit of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
display images including one or more images of a first type and one or more images of a second type in a manner where the one or more images of the first type and the one or more images of the second type are distinguished from each other, wherein the first type of image is an image for receiving execution of processing of a first apparatus alone, and the second type of image is an image for receiving execution of processing involving processing of a second apparatus other than the first apparatus in addition to processing of the first apparatus.

2. The information processing apparatus according to claim 1,
wherein the manner is a first manner that displays the one or more images of the first type with a first image superimposed and the one or more images of the second type with a second image different from the first image superimposed.

3. The information processing apparatus according to claim 1,
wherein the manner displays the one or more images of the first type and the one or more images of the second type respectively grouped.

4. The information processing apparatus according to claim 2,
wherein the manner displays the one or more images of the first type and the one or more images of the second type respectively grouped.

5. The information processing apparatus according to claim 3,
wherein the manner displays the one or more images of the first type and the one or more images of the second type with different backgrounds.

6. The information processing apparatus according to claim 4,
wherein the manner displays the one or more images of the first type and the one or more images of the second type with different backgrounds.

7. The information processing apparatus according to claim 3,
wherein the one or more images of the first type and the one or more images of the second type are displayed on different screens to be distinguishable from each other.

8. The information processing apparatus according to claim 4,
wherein the one or more images of the first type and the one or more images of the second type are displayed on different screens to be distinguishable from each other.

9. The information processing apparatus according to claim 1, wherein the processor is configured to:
display a plurality of images of the second type in a manner that further distinguishes whether corresponding processing of each of the plurality of images involves (i) processing of the second apparatus before processing of the first apparatus or (ii) processing of the second apparatus after processing of the first apparatus.

10. The information processing apparatus according to claim 2, wherein the processor is configured to:
display a plurality of images of the second type in a manner that further distinguishes whether corresponding processing of each of the plurality of images involves (i) processing of the second apparatus before processing of the first apparatus or (ii) processing of the second apparatus after processing of the first apparatus.

11. The information processing apparatus according to claim 3, wherein the processor is configured to:
display a plurality of images of the second type in a manner that further distinguishes whether corresponding processing of each of the plurality of images involves (i) processing of the second apparatus before processing of the first apparatus or (ii) processing of the second apparatus after processing of the first apparatus.

12. The information processing apparatus according to claim 4, wherein the processor is configured to:
display a plurality of images of the second type in a manner that further distinguishes whether corresponding processing of each of the plurality of images involves (i) processing of the second apparatus before processing of the first apparatus or (ii) processing of the second apparatus after processing of the first apparatus.

13. The information processing apparatus according to claim 5, wherein the processor is configured to:
display a plurality of images of the second type in a manner that further distinguishes whether corresponding processing of each of the plurality of images involves (i) processing of the second apparatus before processing of the first apparatus or (ii) processing of the second apparatus after processing of the first apparatus.

14. The information processing apparatus according to claim 6, wherein the processor is configured to:
display a plurality of images of the second type in a manner that further distinguishes whether corresponding processing of each of the plurality of images involves (i) processing of the second apparatus before processing of the first apparatus or (ii) processing of the second apparatus after processing of the first apparatus.

15. The information processing apparatus according to claim 7, wherein the processor is configured to:
display a plurality of images of the second type in a manner that further distinguishes whether corresponding processing of each of the plurality of images involves (i) processing of the second apparatus before processing of the first apparatus or (ii) processing of the second apparatus after processing of the first apparatus.

16. The information processing apparatus according to claim 8, wherein the processor is configured to:
display a plurality of images of the second type in a manner that further distinguishes whether corresponding processing of each of the plurality of images involves (i) processing of the second apparatus before processing of the first apparatus or (ii) processing of the second apparatus after processing of the first apparatus.

17. The information processing apparatus according to claim 9, wherein the processor is configured to:
switch the manner depending on the number of types of processing corresponding to the images to be displayed.

18. The information processing apparatus according to claim 17, wherein the processor is configured to:
display the one or more images of the first type and the one or more images of the second type in the first manner in a case where the number of types is less than a predetermined threshold value; and
display the one or more images of the first type and the one or more images of the second type respectively grouped in a case where the number of types is equal to or greater than the predetermined threshold value.

19. A non-transitory computer readable medium storing an information processing program causing a computer to execute a process comprising:
displaying images including one or more images of a first type and one or more images of a second type in a manner where the one or more images of the first type and the one or more images of the second type are distinguished from each other, wherein the first type of image is an image for receiving execution of processing of a first apparatus alone, and the second type of image is an image for receiving execution of processing involving processing of a second apparatus other than the first apparatus in addition to processing of the first apparatus.

20. An information processing method comprising:
displaying images including one or more images of a first type and one or more images of a second type in a manner where the one or more images of the first type and the one or more images of the second type are distinguished from each other, wherein the first type of image is an image for receiving execution of processing of a first apparatus alone, and the second type of image is an image for receiving execution of processing involving processing of a second apparatus other than the first apparatus in addition to processing of the first apparatus.
